(19) United States
(12) Patent Application Publication
(10) Pub. No.: US 2025/0127165 A1
(43) Pub. Date: Apr. 24, 2025

(54) USE OF 2-AMINO-3-PHENYLBUTYRIC ACID OR 2,6-DIAMINO-3-METHYLHEXANOIC ACID AS PLANT IMMUNE RESISTANCE INDUCER

(71) Applicant: NANJING TIANNONG BIOTECHNOLOGY CO., LTD., Nanjing, Jiangsu (CN)

(72) Inventors: Shiguo CHEN, Nanjing (CN); He WANG, Nanjing (CN); Yanjing GUO, Nanjing (CN); Liru MI, Nanjing (CN); Wanping FANG, Nanjing (CN); Aiping GUO, Nanjing (CN)

(73) Assignee: NANJING TIANNONG BIOTECHNOLOGY CO., LTD., Nanjing, Jiangsu (CN)

(21) Appl. No.: 18/717,186

(22) PCT Filed: Dec. 5, 2022
(86) PCT No.: PCT/CN2022/136490

§ 371 Date: Dec. 30, 2024

(30) Foreign Application Priority Data
Dec. 6, 2021 (CN) 202111479142.7

(51) Int. Cl. A01N 37/44; A01N 25/30; A01P 21/00

(52) U.S. Cl. CPC A01N 37/44; A01N 25/30; A01P 21/00

(57) ABSTRACT

The use of 2-amino-3-phenylbutyric acid or 2,6-diamino-3-methylhexanoic acid as a plant immune resistance inducer. The development of 2-amino-3-phenylbutyric acid and/or 2,6-diamino-3-methylhexanoic acid as an active substance into a plant immune resistance inducer can be used to improve the resistance of plants to biotic and abiotic stresses, effectively prevent the infection and reduce the pathogenic levels of fungi, viruses, and bacteria on plants; Meanwhile, they can significantly improve the resistance of plants to high temperature, low temperature, drought and salt stresses. 2-amino-3-phenylbutyric acid and 2,6-diamino-3-methylhexanoic acid have the features of being safe, environmentally friendly and efficient.

### TECHNICAL FIELD

The invention belongs to the field of agricultural bio-pesticide and relates to the use of 2-amino-3-phenylbutyric acid and/or 2,6-diamino-3-methylhexanoic acid as a plant immune resistance inducer.

### BACKGROUND

In recent years, with the frequent occurrence of extreme weather around the world, agricultural plants are also facing increasing abiotic stresses. The annual losses of agricultural production due to major abiotic stresses such as high temperature, low temperature, drought and salt are enormous. Drought is one of the most important adversity stress factors affecting the survival, growth and distribution of plants. At present, the area of arid and semi-arid regions in the world accounts for 40% or more of the total cultivated land area. High and low temperatures severely affect the growth and development of the plants, which in turn affect their yield and quality. In recent years, due to global climate deterioration, the occurrence frequency of drought, high and low temperature agricultural disasters becomes higher and higher, and the threat to food production security is also increasing. Secondly, soil salinization is a major abiotic limiting factor hindering global crop growth and productivity, and China's saline-alkali land area ranks third in the world, accounting for about 10% of the world's saline-alkali land area. Therefore, in view of the main abiotic stresses faced by different crops in current agricultural practices, it is particularly urgent to develop products and technologies aimed at reducing the level of plant damage to ensure safe agricultural production.

On the other hand, crops are constantly threatened by various diseases and insect pests during their growth and development, and the occurrence and prevalence of some diseases usually result in serious crop reduction or even loss of harvest in large areas. Therefore, it is particularly important to establish a comprehensive management system for important agricultural diseases and insect pests. At present, the main measure for preventing and controlling agricultural plant diseases and insect pests is to use pesticides to directly kill them. However, the long-term and large-scale use of fungicides and insecticides not only brings about a series of problems such as residual pollution, the occurrence of drug resistance, the reduction of biodiversity and food safety, but also makes the traditional “killing” strategy of plant protection face the risk of failure, seriously threatening the food production security and the sustainable development strategy of agriculture. Therefore, it is of great significance to develop environmentally friendly, efficient and economical plant immune resistance inducers to reduce or inhibit the incidence of crop diseases by enhancing the plant's own resistance before the onset or at an early stage of crop diseases, so as to achieve the goal of using little or no chemical fungicides, and to achieve green agricultural production.

Plant immune resistance inducers are a new class of pesticides, which can enhance the disease resistance and stress resistance by activating the plant immune system and regulating the plant metabolism. Plant immune resistance inducers themselves have no insecticidal and bactericidal activities, and are mainly stimulate the plant's own natural immune system by exogenous application to prevent and control diseases and insect pests. Because it does not rely on exogenous pesticides to directly kill pathogens, it is not easy for diseases and insect pests to develop resistance to plant immune resistance inducers, which conforms to the idea of realizing green prevention and control under the conditions of effective protection of agricultural biodiversity. In addition, in nature, the growth of plants is usually subjected to not only a single stress, but also coexistence of multiple stresses, for example, drought and high temperature stresses often occur simultaneously, causing more severe damage to plants. Although plants have their own immune system, their ability to resist adversity stress is limited. The use of plant immune resistance inducers can increase the stress resistance level of plants. Therefore, plant immune resistance inducers, as a class of emerging pesticides, provide new development ideas for sustainable development of agriculture and effective green prevention and control of diseases, and are the main direction for the future development of green plant protection.

2-amino-3-phenylbutyric acid having molecular formula of C₁₀H₁₃NO₂ and the molecular weight of 179 g/mol belongs to a novel amino acid compound, which is colorless transparent crystal. In 1963, 2-amino-3-phenylbutyric acid was first chemically synthesized, and activity tests showed that it inhibited the growth of Leuconostoc dextranicum (Edelson & Keeley, 1963). In 2002, 2-amino-3-phenylbutyric acid was detected by He et al in the hydrolysate of mannopeptimycin, a secondary metabolite of Streptomyces hygroscopicus, which demonstrated that this amino acid was one of constituent structures of mannopeptimycin (He et al., 2002). Some studies have shown that 2-amino-3-phenylbutyric acid can be used as a pharmaceutical adjuvant (carrier or absorption enhancer or humectant), such as pharmaceutical composition for the surgical local anesthetic lidocaine (Liu Li, 2017), injection for prevention or treatment of deficiency of multiple trace elements in humans and mammals (Liu Li, 2018), and composition of puerarin eye drops for topical administration (Liu Li, 2021). In 2019, Ren et al. found that 2-amino-3-phenylbutyric acid can alleviate arthritis in rats at treatment concentrations of 100 mg/kg and 200 mg/kg (Ren et al., 2019). Feng et al. found that 2-amino-3-phenylbutyric acid may have therapeutic effects on Parkinson's disease (Feng et al., 2020). In all the reports described above, 2-amino-3-phenylbutyric acid is obtained by chemical synthesis or hydrolysis. To date, there are no reports on the compound being naturally present in free form. Therefore, 2-amino-3-phenylbutyric acid is considered to be an unnatural amino acid. So far, there are few studies on 2-amino-3-phenylbutyric acid, and the only studies focus on chemical synthesis and chiral resolution of isomers (Grobuschek et al., 2002; Vékes et al., 2002) or medicinal use, and there are no related studies, reports and patents that relate to natural products and plant activity. There are few studies on 2,6-diamino-3-methylhexanoic acid, and there are no related studies, reports and patents on natural products and the activity of plant immune resistance inducer.

2,6-diamino-3-methylhexanoic acid has molecular formula of C₇H₁₆N₂O₂ and molecular weight of 160 g/mol, and is colorless crystal. At present, there are few studies on this compound, and it was first reported in 1969 that 2,6-diamino-3-methylhexanoic acid was obtained by chemical synthesis (Takehara & Yoshida, 1969). The specificity of lysine monooxygenase for this compound was subsequently studied and the results showed that 2,6-diamino-3-methylhexanoic acid has no substrate activity for this enzyme (Ohnishi et al., 1976). Up to now, there are few studies on 2,6-diamino-3-methylhexanoic acid, and there are no related studies, reports and patents related to natural products and the activity of plant immune resistance inducer.

### SUMMARY OF THE INVENTION

An objective of the present invention is to provide the use of 2-amino-3-phenylbutyric acid and 2,6-diamino-3-methylhexanoic acid as plant immune resistance inducers in view of the above shortcomings of the prior art.

We successfully isolate and purify 2-amino-3-phenylbutyric acid and 2,6-diamino-3-methylhexanoic acid from the plant pathogenic fungus Alternata sp. This is the first time that free 2-amino-3-phenylbutyric acid and 2,6-diamino-3-methylhexanoic acid are isolated from natural microorganisms, and their contents are high, which demonstrate that they are two novel natural amino acids. The studies on the activities of plant resistance inducers find that in terms of resistance to biotic stress, 2-amino-3-phenylbutyric acid and 2,6-diamino-3-methylhexanoic acid can effectively inhibit the development and spread of viruses, fungi and bacteria on plant leaves; in terms of inducing the resistance of plants to abiotic stresses, both 2-amino-3-phenylbutyric acid and 2,6-diamino-3-methylhexanoic acid could effectively alleviate the injuries caused by high temperature, low temperature, drought and salt.

The objective of the present invention can be achieved through the following technical solutions.

2-amino-3-phenylbutyric acid and 2,6-diamino-3-methylhexanoic acid are both natural products isolated from Alternata sp., and the structural formula of 2-amino-3-phenylbutyric acid is as follows:

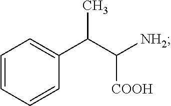

the structural formula of 2,6-diamino-3-methylhexanoic acid is as follows:

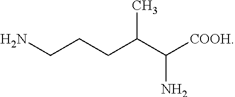

Use of 2-amino-3-phenylbutyric acid and/or 2,6-diamino-3-methylhexanoic in the preparation of a plant immune resistance inducer.

Use of 2-amino-3-phenylbutyric acid and/or 2,6-diamino-3-methylhexanoic acid in improving plant resistance to abiotic and/or biotic stresses.

Use of 2-amino-3-phenylbutyric acid and/or 2,6-diamino-3-methylhexanoic acid in improving plant resistance to high and low temperatures, drought, and/or salt stresses.

Use of 2-amino-3-phenylbutyric acid and/or 2,6-diamino-3-methylhexanoic acid in improving plant resistance to fungal, bacterial and viral stresses.

Use of 2-amino-3-phenylbutyric acid and/or 2,6-diamino-3-methylhexanoic acid in preventing and controlling plant fungal, bacterial and/or viral diseases.

The fungal disease is preferably wheat powdery mildew; the bacterial disease is preferably Pseudomonas syringae disease; the viral disease is preferably tomato spotted wilt.

The plants are selected from food crops, cash crops and vegetables. The grain crop is preferably wheat; the cash crop is preferably ryegrass, tea, and cotton; and the vegetable is preferably tomato.

A plant immune resistance inducer, comprising 2-amino-3-phenylbutyric acid and/or 2,6-diamino-3-methylhexanoic acid.

As a preferred aspect of the present invention, the plant immune resistance inducer comprises component A: any one or more of 2-amino-3-phenylbutyric acid or 2,6-diamino-3-methylhexanoic acid; and component B: a surfactant.

As a further preferred aspect of the present invention, the surfactant is Tween 20, and the concentration of Tween 20 in the plant immune resistance inducer is preferably 0.02% (v/v).

As a further preferred aspect of the present invention, the concentration of 2-amino-3-phenylbutyric acid or 2,6-diamino-3-methylcaproic acid in the plant immune resistance inducer is 0.1-10,000 nM.

Previous studies of 2-amino-3-phenylbutyric acid and 2,6-diamino-3-methylhexanoic acid have not involved the reports on the fields of natural microbial metabolites and bio-pesticides. The plant immune resistance inducers belong to novel pesticides, which are the main development direction of green prevention and control in the field of plant protection in the future. The development of immune resistance inducers in China is in its infancy, and there are few products officially registered. Therefore, it is of great significance to develop natural plant immune resistance inducers and promote their industrialization for guaranteeing the food production security and improving the competitiveness of agricultural products. The studies of the invention show that 2-amino-3-phenylbutyric acid and 2,6-diamino-3-methylhexanoic acid perform well in relevant experiments of induction of immunity and resistance to stresses, and are able to improve the resistance of plants to biotic and abiotic stresses.

A method for preventing and controlling diseases using the natural metabolites 2-amino-3-phenylbutyric acid and 2,6-diamino-3-methylhexanoic acid isolated from the saprophytic fungus Alternata sp., comprising the details and embodiments as follows: at a concentration range of 0.1-10,000 nM (with 0.02% by volume of surfactant Tween 20), they can effectively inhibit the infection and spread of viruses, fungi and bacteria on plants, inhibit the occurrence and spread of diseases, and improve the resistance of plants to high and low temperatures, drought and salt stresses.

A method for improving the resistance of plants to biotic stresses, comprising applying to the plant in advance the plant immune resistance inducer of the present invention to plants in advance; the biotic stresses are selected from any one or more of fungal, bacterial, or viral stresses.

A method for preventing and controlling tomato spotted wilt using 2-amino-3-phenylbutyric acid, wherein 2-amino-3-phenylbutyric acid can significantly inhibit the spread of tomato spotted wilt virus (TSWV) at 3 days after inoculation of tobacco with the virus in the concentration range of 0.1-10 nM (with 0.02% by volume of surfactant Tween 20). After 15 days, the diseases of tobacco are investigated, and it is found that the disease index of tobacco plants treated with 2-amino-3-phenylbutyric acid significantly decreases. At a concentration of 10 nM, the expression of TSWV on tobacco leaves could be effectively inhibited, with the disease index, relative immunization effect and virus content of 20.95, 69.23% and 0.10, respectively.

A method for preventing and controlling tomato spotted wilt using 2,6-diamino-3-methylhexanoic acid, wherein 2,6-diamino-3-methylhexanoic acid can significantly inhibit the spread of tomato spotted wilt virus (TSWV) at 3 days after inoculation of tobacco with the virus in the concentration range of 0.1-10 nM (with 0.02% by volume of surfactant Tween 20). After 15 days, the diseases of tobacco are investigated, and it is found that the disease index of tobacco plants treated with 2,6-diamino-3-methylhexanoic acid significantly decreases. At a low concentration of 10 nM, the expression of TSWV on tobacco leaves could be effectively inhibited, with the disease index, relative immunization effect and virus content of 26.41, 70.94% and 0.12, respectively.

A method for preventing and controlling wheat powdery mildew using 2-amino-3-phenylbutyric acid, wherein the investigation is performed in the concentration range of 10-10,000 nM (with 0.02% by volume of surfactant Tween 20) at 10 days after inoculation of wheat with powdery mildew virus, and the result shows that with the increase of treatment concentration, the disease index of wheat powdery mildew decreases, and the relative immunization effect improves, wherein the disease index is 31.85, and the relative immunization effect is 66.92% when the wheat is treated at the high concentration of 10000 nM.

A method for preventing and controlling wheat powdery mildew using 2,6-diamino-3-methylhexanoic acid, wherein the investigation is performed in the concentration range of 100-10,000 nM (with 0.02% by volume of surfactant Tween 20) at 10 days after inoculation of wheat with powdery mildew virus, and the result shows that with the increase of treatment concentration, the disease index of wheat powdery mildew decreases, and the relative immunization effect improves, wherein the disease index is 25.64, and the relative immunization effect is 73.45% when the wheat is treated at the high concentration of 10,000 nM.

A method for preventing and controlling wheat powdery mildew in the field using 2-amino-3-phenylbutyric acid, wherein the disease index of the wheat is 25.30 at treatment concentration of 1,000 nM, which is significantly lower than that of Atailing group and auxiliary control group, and the relative immunization effect and thousand grain weight are 51.72% and 38.87 g, respectively, which are significantly higher than that of Atailing group and auxiliary control group. In conclusion, 2-amino-3-phenylbutyric acid has a significant inhibitory effect on the development and spread of wheat powdery mildew.

A method for preventing and controlling bacterial diseases using 2-amino-3-phenylbutyric acid, wherein in the concentration range of 100-10,000 nM (with 0.02% by volume of surfactant Tween 20), the accumulation number of bacterial PstDC3000 in Arabidopsis thaliana leaves gradually decreases with the increase of the treatment concentration, and when the treatment concentration is 10,000 nM, the number of the bacteria per mg leaves is 1.34×10⁵, which decreases by 95.56% compared with the blank control, and the disease index is 14.58. This result suggests that 2-amino-3-phenylbutyric acid can stimulate the autoimmunity of Arabidopsis thaliana, inhibit the propagation of bacteria in plants, reduce the accumulation number of bacteria, and delay and inhibit the development of diseases.

A method for preventing and controlling bacterial diseases using 2,6-diamino-3-methylhexanoic acid, wherein in the concentration range of 100-10,000 nM (with 0.02% by volume of surfactant Tween 20), the accumulation number of bacterial PstDC3000 in Arabidopsis thaliana leaves gradually decreases with the increase of the treatment concentration, and when the treatment concentration is 10,000 nM, the number of the bacteria per mg leaves is 1.58×10⁵, which decreases by 95.11% compared with the blank control, and the disease index is 19.86. This result suggests that 2,6-diamino-3-methylhexanoic acid can stimulate the autoimmunity of Arabidopsis thaliana, inhibit the propagation of bacteria in plants, reduce the accumulation number of bacteria, and delay and inhibit the development of diseases.

A method for improving the resistance of plants to abiotic stresses, comprising applying to plants the plant immune resistance inducer of the invention; the abiotic stresses are selected from any one or more of the high temperature, low temperature, drought and/or salt stresses.

A method for improving the resistance of plants to high temperature using 2-amino-3-phenylbutyric acid, wherein the Arabidopsis thaliana at seedling stage is treated and induced with 2-amino-3-phenylbutyric acid solutions (with 0.02% by volume of surfactant Tween 20) at concentrations between 100-10,000 nM, and it is found that after high temperature treatment at 45° C. for 12 h and recovery at room temperature for 7 days, the photosynthetic performance indexes PI_{ABS} of plants in the treatment groups are higher than those of the control group, and the heat injury indexes are lower than those of the control group. This result suggests that exogenous spraying of 2-amino-3-phenylbutyric acid solution could effectively alleviate the injury level of seedlings caused by high temperature.

A method for improving the resistance of plants to high temperature using 2,6-diamino-3-methylhexanoic acid, wherein the ryegrass seedlings and Arabidopsis thaliana are treated and induced with 2,6-diamino-3-methylhexanoic acid solutions (with 0.02% by volume of surfactant Tween 20) at concentrations between 1-1,000 nM, and it is found that after high temperature treatment at 45° C. for 12 h and recovery at room temperature for 7 days, the photosynthetic performance indexes PI_{ABS} of plants in the treatment groups are higher than those of the control group, and the heat injury indexes are lower than those of the control group. This result suggests that exogenous spraying of 2,6-diamino-3-methylhexanoic acid solution could effectively alleviate the injury level of seedlings caused by high temperature.

A method for improving the resistance of plants to low temperature using 2-amino-3-phenylbutyric acid, wherein tea seedlings are treated with 2-amino-3-phenylbutyric acid solutions (with 0.02% by volume of surfactant Tween 20) at a concentration range of 100-10,000 nM by spraying on the leaf surface, and it is found that after low temperature stress at −4° C. for 24 h, the photosynthetic performance indexes PI_{ABS} of the tea seedlings treated at concentrations of 100 nM, 1,000 nM, and 10,000 nM are significantly higher than those of the control group, and the cold injury indexes are significantly lower than those of the control group, which suggest that 2-amino-3-phenylbutyric acid effectively alleviates the injuries caused by low temperature on tea seedlings and improves the resistance of tea seedlings to low temperature stress.

A method for improving the resistance of plants to low temperature using 2,6-diamino-3-methylhexanoic acid, wherein tea seedlings are treated with 2,6-diamino-3-methylhexanoic acid solutions (with 0.02% by volume of surfactant Tween 20) at a concentration range of 1-1,000 nM by spraying on the leaf surface, and it is found that after low temperature stress at −4° C. for 24 h, the photosynthetic performance indexes PI_{ABS} of the tea seedlings treated at concentrations of 1 nM, 10 nM, 100 nM, and 1,000 nM are significantly higher than those of the control group, and the cold injury indexes are significantly lower than those of the control group, which suggest that 2,6-diamino-3-methylhexanoic acid effectively alleviates the injuries caused by the low temperature to the tea seedlings, and improves the resistance of tea to low temperature stress.

A method for improving the resistance of plants to drought stress using 2-amino-3-phenylbutyric acid, wherein hydroponic wheats with two leaves and one bud are treated with 100 and 1,000 nM 2-amino-3-phenylbutyric acid solutions (with 0.02% by volume of surfactant Tween 20) by spraying on the leaf surface, and it is found that under the stress of 25% polyethylene glycol-6000 (PEG-6000), the biomasses of wheats treated at concentrations of 100 nM and 1,000 nM are significantly higher than those of the control group, this result suggests that 2-amino-3-phenylbutyric acid improves the resistance of wheat to drought stress.

A method for improving the resistance of plants to drought stress using 2,6-diamino-3-methylhexanoic acid, wherein hydroponic wheats with two leaves and one bud are treated with 100 and 1,000 nM 2,6-diamino-3-methylhexanoic acid solutions (with 0.02% by volume of surfactant Tween 20) by spraying on the leaf surface, and it is found that under the stress of 25% polyethylene glycol-6000 (PEG-6000), the biomasses of wheats treated at concentrations of 100 nM and 1,000 nM are significantly higher than those of the control group, this result suggests that 2,6-diamino-3-methylhexanoic acid improves the resistance of wheat to drought stress.

A method for improving the resistance of plants to salt stress using 2-amino-3-phenylbutyric acid, wherein hydroponic cottons at the two true leaf stage are treated with 2-amino-3-phenylbutyric acid solutions (with 0.02% by volume addition of surfactant Tween 20) at a concentration range of 1-1,000 nM by spraying on the leaf surface, and it is found that under the stress of 100 mM NaCl, the mortality and salt injury index of cottons in each treatment group spayed with 2-amino-3-phenylbutyric acid are lower than those of the control group.

This result suggests that 2-amino-3-phenylbutyric acid improves the resistance level of cotton to salt stress.

A method for improving the resistance of plants to salt stress using 2,6-diamino-3-methylhexanoic acid, wherein hydroponic cottons at the two true leaf stage are treated with 2,6-diamino-3-methylhexanoic acid solutions (with 0.02% by volume of surfactant Tween 20) at a concentration range of 1-1,000 nM by spraying on the leaf surface, and it is found that under the stress of 100 mM NaCl, the mortality and salt injury index of cottons in each treatment group spayed with 2,6-diamino-3-methylhexanoic acid are lower than those of the control group. This result suggests that 2,6-diamino-3-methylhexanoic acid improves the resistance level of cotton to salt stress.

### Technical Advancement and Beneficial Effects

The main advantages and positive effects of the present invention are as follows.

2-amino-3-phenylbutyric acid and 2,6-diamino-3-methylhexanoic acid are natural products with simple structures, and can be obtained by simple biological extraction methods. Since the present invention confirms that 2-amino-3-phenylbutyric acid and 2,6-diamino-3-methylhexanoic acid can induce plants to produce immune activity against some serious diseases in agricultural production, and can induce plants to produce resistance to the major abiotic stresses currently faced in agricultural production, they have the potential to be developed as natural plant immune resistance inducers.

The present invention discovers that both 2-amino-3-phenylbutyric acid and 2,6-diamino-3-methylhexanoic acid have high broad-spectrum immune-inducing activity, and can induce tobacco to produce an immune response to prevent the development and spread of tomato spotted wilt at a low concentration of 0.1 nM; when the concentration is 1,000 nM, they can induce wheat to produce 55.38% and 65.26% relative immunization effects against powdery mildew, respectively; and when the concentration is 100 nM, they can inhibit the accumulation of Pseudomonas syringae PstDC3000 in leaves of Arabidopsis thaliana, and reduce the disease index of Arabidopsis thaliana. In response to abiotic stresses, they can induce the resistance of Arabidopsis thaliana to high temperature, wheat to drought and tea to low temperature at a concentration of 100-10,000 nM, and they can significantly improve the resistance of cotton to salt at a concentration of 100 nM. 2-amino-3-phenylbutyric acid and 2,6-diamino-3-methylhexanoic acid are efficient bio-pesticides due to their low dosage, safety and environmental friendliness, which indicates the great utilization value and broad application prospects thereof in agricultural production.

2-amino-3-phenylbutyric acid and 2,6-diamino-3-methylhexanoic acid can be used to control major fungal diseases occurring in farmland, such as wheat powdery mildew; viral disease, such as tomato spotted wilt; bacterial disease, such as those caused by Pseudomonas syringae. This suggests that the compound can induce plants to produce immune responses against multiple types of diseases. At the same time, it can induce plants to resist a variety of abiotic stresses in nature, such as high temperature, low temperature, drought and salt stresses, providing a technical reference for alleviating the injuries caused by various stresses on plants.

The present invention discovers that treatment of stems and leaves with 2-amino-3-phenylbutyric acid and 2,6-diamino-3-methylhexanoic acid can prevent the development and spread of a variety of major diseases in agricultural production, and can reduce the inhibition of various abiotic stresses to which crops are subjected during their growth and development. 2-amino-3-phenylbutyric acid and 2,6-diamino-3-methylhexanoic acid are easy to use and can play a role in early prevention, reduce the injury grade of plants caused by a variety of biotic and abiotic stresses, reduce the amounts of pesticides used, save on production costs and reduce carbon emissions. In addition, 2-amino-3-phenylbutyric acid and 2,6-diamino-3-methylhexanoic acid are naturally occurring metabolites with simple structure and belong to a-amino acids, which have high environmental and biological safety, and thus belong to the category of green and efficient bio-pesticides.

### DETAILED DESCRIPTION OF EMBODIMENTS

The inventors isolated and purified 2-amino-3-phenylbutyric acid and 2,6-diamino-3-methylhexanoic acid from Alternata sp., and characterized their structures. Subsequently, the biological activity, scope of application and crop safety studies were carried out, and the substances were found to be natural plant immune resistance inducers with the potential to be developed into a bio-pesticide. At the same time, the research ideas provide a new direction for the development of bio-pesticides, the prevention and treatment of disease and the alleviation of abiotic stress. The substantial features of the present invention may be embodied in the following embodiments and examples, but these should not be construed as any limitation of the invention.

### Example 1 (Biosynthesis, Extraction Method and Structural Characterization of Compounds of the Invention)

### (1) Culture of Alternaria

Glucose sodium nitrate medium: glucose, 40.0 g; NaNO₃, 1.0 g; NH₄Cl, 0.25 g; KH₂PO₄, 1.0 g; KCl, 0.25 g; NaCl, 0.25 g; MgSO₄·7H₂O, 0.5 g; FeSO₄·7H₂O, 0.01 g; ZnSO₄·7H₂O, 0.01 g; yeast extract, 1 g; adding water to 1 L, and adjusting the pH to 5.5.

Cultivation method of Alternata sp.: The preserved strains were activated with PDA medium, and after 7 days, the colonies with consistent growth were selected, the bacterial cakes with a diameter of 5 mm were taken, and inoculated into 500 mL of medium at inoculation amount of one cake per 100 mL. The medium inoculated with bacterial cakes was placed in a constant temperature shaker under the following conditions: 140 rpm, 25° C., and under dark for 7 days.

### (2) Extraction of Compound

Mycelium was isolated from the fermentation liquor after 7 days of culture. Separation was carried out using a centrifuge by centrifuging at 10,000 rpm for 5 min. The supernatant was removed, and the mycelium was transferred from the bottom of the shake flask to a mortar, and quickly ground into a uniform powder with liquid nitrogen. The powder was charged into a centrifuge tube, 5 mL of water was added and shaken uniformly. The tube was left to stand for 1 hour. The precipitate was removed by centrifugation at 10,000 rpm for 5 min. The resultant supernatant was the crude extracts of amino acid.

### (3) Separation and Purification of 2-Amino-3-Phenylbutyric Acid by HPLC

The amino acid crude extracts were separated and purified using high performance liquid chromatography with dual mobile phase elution. The elution conditions were: A: 60% water (with 0.1% formic acid solution), B: 40% acetonitrile, UV detection wavelength: 256 nm, flow rate: 2 mL min-1. After separation, the impurities in the crude extracts can be removed, and a single component of 2-amino-3-phenylbutyric acid was obtained with a peak time of 7.9 min. This method can effectively isolate this compound from Alternata sp.

The isolated 2-amino-3-phenylbutyric acid was structurally characterized by NMR and mass spectrometry.

The NMR results are as follows:

¹H NMR (500 MHz, Deuterium Oxide) δ 7.33-7.21 (m, 5H, Ph), 3.81-3.66 (dd, J₁=5 Hz, J₂=10 Hz, 1H, CH—NH₂), 3.45-3.09 (m, 1H, CHCH₃), 1.29-1.25 (dd, J₁=10 Hz, J₂=10 Hz, 3H, CHCH₃).

¹³C NMR (125 MHz, Deuterium Oxide) δ 173.78 (CHCOOH), 140.23 (Ph), 129.27 (Ph), 129.11 (Ph), 127.98 (Ph), 127.88 (Ph), 127.77 (Ph), 60.98 (CHNH₂), 40.80 (CHCH₃), 17.67 (CHCH₃).

Mass spectrometry shows the molecular ion peaks of the compound is 180.1020 [M+H]⁺, and the molecular formula is determined to be C₁₀H₁₃NO₂. The compound is identified as 2-amino-3-phenylbutyric acid by combining the results of ¹H NMR and ¹³C NMR spectra.

### (4) Separation and Purification of 2,6-Diamino-3-Methylhexanoic Acid by HPLC

The amino acid crude extracts were separated and purified using high performance liquid chromatography with dual mobile phase elution. The elution conditions were: A: 60% water (with 0.1% formic acid solution), B: 40% acetonitrile, UV detection wavelength: 210 nm, flow rate: 2 mL min-1. After separation, the impurities in the crude extracts can be removed, and a single component of 2,6-diamino-3-methylhexanoic acid was obtained with a peak time of 4.3 min. This method can effectively isolate this compound from Alternata sp.

The isolated 2,6-diamino-3-methylhexanoic acid was structurally characterized by NMR and mass spectrometry, and the NMR results were as follows:

¹H NMR (500 MHZ, Deuterium Oxide) δ 12.13 (br, 1H, OH), 8.34 (br, 2H, CHNH₂), 3.83 (d, J=5 Hz, 1H, CHNH₂), 2.63 (t, J=5 Hz, 2H, CH₂NH₂), 1.53-1.19 (m, 4H, CH₂CH₂CH₂NH₂), 1.11 (d, J=5 Hz, 3H, CHCH₃).

¹³C NMR (125 MHZ, Deuterium Oxide) δ 175.16 (CHCOOH), 59.51 (CHCOOH), 42.62 (CH₂NH₂), 36.27 (CHCH₃), 29.93 (CH₂CH₂CH₂NH₂), 28.82 (CH₂CH₂CH₂NH₂), 13.41 (CHCH₃).

Mass spectrometry shows the molecular ion peaks of the compound is 161.1203 [M+H]⁺, and the molecular formula is determined to be C₇H₁₆N₂O₂. The compound is identified as 2,6-diamino-3-methylhexanoic acid by combining the results of ¹H NMR and ¹³C NMR spectra.

### Example 2 (2-Amino-3-Phenylbutyric Acid and 2,6-Diamino-3-Methylhexanoic Acid Induced the Resistance of Tobacco to Tomato Spotted Wilt Virus Infection)

Tomato spotted wilt virus was obtained from Yunnan Province, China. The initial virus source was stored in a refrigerator at −80° C., and inoculated on the leaves of Nicotiana benthamiana using friction inoculation method to activate the virus. The virus plasmids were extracted and transformed with competent cells of Escherichia coli. The competent cells were coated on a resistant plate for culture. Single colonies were picked for PCR screening, and positive colonies were selected for sequencing and subsequent plasmid extraction. The plasmids with normal sequencing results were added to competent cells of Agrobacterium sp, and Agrobacterium was transformated by electroporation. A solution of the transformed Agrobacterium was coated on the corresponding resistant screening plate, and cultured at 28° C. (+1° C.) for 48 h. Single colonies of the Agrobacterium on transformation plate were picked, placed in 5 mL of LB medium with the corresponding resistance, and cultured overnight at 28° C., 180 rpm. The bacterial cells were collected by centrifugation at 6,000 rpm for 2 min, suspended with a treatment solution (10 mM MgCl₂, 10 mM MES, and 10 μM Acetosyringone) until the OD₆₀₀ value of the suspension was 0.5. The suspension was treated at 28° C. in the dark for 3 hours for later use. 2-amino-3-phenylbutyric acid was dissolved in distilled water and then gradiently diluted with distilled water into solutions of 0 nM, 0.1 nM, 1 nM, and 10 nM. Nicotiana benthamiana seeds were planted in small pots and incubated at 22° C. (+1° C.), 12 h/12 h light for 5 weeks. Healthy tobacco plants (preferably with 8-10 leaves) were selected and treated with the 2-amino-3-phenylbutyric acid solutions of the above concentrations by spraying on the stems and leaves, and repeated the treatment at 24-hour intervals for a total of two treatments. After 24 hours, a uniform concentration of Agrobacterium solution was extracted with a 1 mL syringe, the injection port of the syringe was pressed directly on the small hole on the back of the tobacco leaf, and the bacterial solution was slowly pushed in order to infiltrate soak the entire leaf. The infiltrated tobacco was moved to an environment of 24° C. (+1° C.), 12 h/12 h light for incubation. After 3 days, microscopic observation was performed and recorded. At the same time, the samples were taken, and the gray scale of protein bands was analyzed by Western blot combined with Image J software to determine the relative protein content of virus in leaves. After 15 days, the disease of tobacco leaves was observed and the disease index was recorded with reference to “grade and investigation method of tobacco diseases and insect pests” (GB/T 23222-2008) with the following formulas:

$$Disease index = \frac{\begin{matrix}\sum [ ( Number of diseased leaves at all grades \times \\ Relative grade value ) ] \times 100\end{matrix}}{Total Number of leaves investigated \times 9}$$

$$Relative immunization effect = \frac{Disease index of blank control - Disease index of treatment}{Disease index of blank control} \times 100 \%$$

Grading standard of Tomato spotted wilt virus disease (grading and investigation were conducted per plant):
Grade 0: the whole plant is disease free;
Grade 1: heart leaves have clear veins or slightly mosaic, and there is no obvious dwarfing of diseased plants;
Grade 3: one-third of the leaves are mosaic without deformation, or the diseased plant is dwarfed to three quarters or more of the normal plant height;
Grade 5: one-third to one-half of the leaves are mosaic, or a few leaves are deformed, or the main veins become black, or the diseased plant is dwarfed to two-thirds to three-quarters of the normal plant height;
Grade 7: one-half to two-thirds of the leaves are mosaic or deformed, or a few main and lateral veins become necrotic, or the diseased plant is dwarfed to one-half to two-thirds of the normal plant height;
Grade 9: the leaves of the whole plant are mosaic, severely deformed or necrotic, or the diseased plant is dwarfed to one-half or more of the normal plant height.

TABLE 1
Effects of 2-amino-3-phenylbutyric acid of different concentrations
on tobacco infected with tomato spotted wilt virus

| | | relative | |
|---|---|---|---|
| treatment | | immunization | viral protein |
| concentration | disease index | effect (%) | content |
| 0 | 75.93 ± 4.00 a | 0 | 0.52 ± 0.005 a |
| 0.1 nM | 48.77 ± 0.87 b | 35.77 | 0.33 ± 0.003 b |
| 1 nM | 29.63 ± 1.51 c | 60.98 | 0.14 ± 0.008 c |
| 10 nM | 20.95 ± 0.87 c | 69.23 | 0.10 ± 0.009 c |

The results in Table 1 shows that when the 2-amino-3-phenylbutyric acid is in a concentration range of 0.1-10 nM, each treatment can significantly reduce the infection of tobacco with tomato spotted wilt virus. The disease index of tobacco infected with tomato spotted wilt virus is lower than 50, and the relative immune effect is 35% or more. Compared with the control group not sprayed with 2-amino-3-phenylbutyric acid, with the increase of the concentration in this concentration range, the disease index of tobacco infected with tomato spotted wilt virus significantly decreases, the relative immunization effect significantly increases, and the viral protein content in the tobacco leaves significantly decreases. For example, when the treatment concentration is 10 nM, the best immunization effect of tobacco against tomato spotted wilt virus is achieved, and the disease index, relative immunization effect and virus content are 20.95, 69.23%, and 0.10, respectively. The above results indicate that 2-amino-3-phenylbutyric acid can improve the immunity of tobacco against tomato spotted wilt virus and effectively inhibit the spread of tomato spotted wilt virus in tobacco.

The effect of 2-amino-3-phenylbutyric acid to induce the resistance of tobacco to tomato spotted wilt virus infection was investigated according to the same method. The results are shown in Table 2:

TABLE 2
Effects of 2,6-diamino-3-methylhexanoic acid at different
concentrations on tobacco infested with tomato spotted wilt virus

| | | relative | viral |
|---|---|---|---|
| treatment | | immunization | protein |
| concentration | disease index | effect (%) | content |
| 0 | 90.87 ± 0.93 a | 0 | 0.63 ± 0.0013 a |
| 0.1 nM | 42.64 ± 1.25 b | 53.08 | 0.41 ± 0.005 b |
| 1 nM | 32.97 ± 1.26 c | 63.72 | 0.23 ± 0.002 c |
| 10 nM | 26.41 ± 0.83 c | 70.94 | 0.12 ± 0.001 c |

The results in Table 2 show that when 2,6-diamino-3-methylhexanoic acid is in the concentration range of 0.1-10 nM, each treatment can significantly reduce the infection of tobacco with tomato spotted wilt virus. The disease index of tobacco infected with tomato spotted wilt virus is lower than 50, and the relative immune effect is 50% or more. Also, compared with the control group, with the increase of the concentration in this concentration range, the disease index of tobacco infected with tomato spotted wilt virus significantly decreases, the relative immunization effect significantly increases, and the virus protein content in tobacco leaves significantly decreases. When the treatment concentration is 10 nM, the best immunization of tobacco against tomato spotted wilt virus is achieved, and the disease index, relative immunization effect and virus content are 26.41, 70.94%, and 0.12, respectively. The above results indicate that 2,6-diamino-3-methylhexanoic acid can improve the immunity of tobacco against tomato spotted wilt virus and effectively inhibit the spread of tomato spotted wilt virus in tobacco.

### Example 3 (2-Amino-3-Phenylbutyric Acid and 2,6-Diamino-3-Methylhexanoic Acid Induced Resistance of Wheat to Powdery Mildew Infection)

2-amino-3-phenylbutyric acid was dissolved in distilled water and then gradiently diluted with distilled water into solutions of 10 nM, 100 nM, 1,000 nM, and 10,000 nM, and a blank control was set up. After germination, wheat (NAU0686) seeds were planted in sterilized soil culture pot, and cultured in a greenhouse at 23° C. (+1° C.) and 12-h light/dark conditions. When the seedlings grew to the 1-leaf-1-heart stage, a solution of 2-amino-3-phenylbutyric acid at the above concentrations was sprayed onto the stems and leaves of wheat seedlings, and repeated the treatment at 24-hour intervals for a total of two treatments. After 24 hours, fresh wheat powdery mildew spores were uniformly sprinkled onto the wheat leaves, and each treatment comprised three pots of seedlings, with 20 plants per pot. After 10 days, the disease grade of wheat in each treatment group was investigated, and the morbidity degree was recorded according to the grading standard of wheat powdery in the “Pesticides-Guidelines for the Field Efficacy Trails” (I), and the disease index and the relative immunization effect were calculated in the same manner as those of tomato spotted wilt. The results are shown in Table 3.

Grading Standard of Wheat Powdery Mildew (per leaf):
Grade 1: The area of diseased spots accounts for 5% or less of the whole leaf area;
Grade 3: The area of diseased spots accounts for 6%-15% of the whole leaf;
Grade 5: The area of diseased spots accounts for 16%-25% of the whole leaf;
Grade 7: The area of diseased spots accounts for 26%-50% of the whole leaf;
Grade 9: The area of diseased spots accounts for 50% or more of the whole leaf area.

TABLE 3
Effects of 2-amino-3-phenylbutyric acid on the disease index
and relative immunization effect of wheat

| treatment | | relative immunization |
|---|---|---|
| concentration | disease index | effect (%) |
| 0 | 96.30 ± 1.05 a | 0 |
| 10 nM | 77.15 ± 0.47 b | 19.88 |
| 100 nM | 66.67 ± 1.81 c | 30.77 |
| 1,000 nM | 42.96 ± 2.77 d | 55.38 |
| 10,000 nM | 31.85 ± 3.77 e | 66.92 |

The results in Table 3 show that with the increase of the concentration of 2-amino-3-phenylbutyric acid, the disease index of the susceptible wheat varieties decreases, and the relative immunization effect increases. There are significant differences in the disease index among each treatment. When the concentration is 10 nM, 100 nM, 1,000 nM, and 10,000 nM, the disease indexes is 77.15, 66.67, 42.96, and 31.85 and the relative immunization effect is 19.88%, 30.77%, 55.38%, and 66.92%, respectively. When the concentration of 2-amino-3-phenylbutyric acid is higher than 1,000 nM, the disease index of susceptible wheat varieties infected with powdery mildew is lower than 50, while the relative immunization effect is more than 50%. The best effect is achieved at the concentration of 10,000 nM. These results indicate that 2-amino-3-phenylbutyric acid can improve the immunity of wheat to fungal disease powdery mildew, thereby inhibiting the infection and spread of powdery mildew in wheat leaves and preventing the development and spread of wheat powdery mildew.

2,6-diamino-3-methylhexanoic acid was dissolved in distilled water and then gradiently diluted with distilled water into solutions of 100 nM, 1,000 nM, and 10,000 nM, and a blank control was set up. The effect of 2-amino-3-phenylbutyric acid to induce the resistance of wheat to powdery mildew infection was investigated according to the above method, and the results were shown in Table 4:

TABLE 4
Effects of 2,6-diamino-3-methylhexanoic acid at different concentrations
on the disease index and relative immunization effect of wheat

| treatment concentration | disease index | relative immunization effect (%) |
|---|---|---|
| 0 | 96.58 ± 2.47 a | — |
| 10 nM | 69.41 ± 1.49 b | 28.13 |
| 100 nM | 49.27 ± 1.34 c | 48.99 |
| 1,000 nM | 33.55 ± 2.45 d | 65.26 |
| 10,000 nM | 25.64 ± 1.37 e | 73.45 |

The results in Table 4 indicate that with the increase of the concentration of 2,6-diamino-3-methylhexanoic acid, the disease index of susceptible wheat varieties decreases and the relative immunization effect increases. There are significant differences in the disease index among each treatment. When the concentration is 10 nM, 100 nM, 1,000 nM, and 10,000 nM, the disease index is 69.41, 49.27, 33.55, and 25.64 and the relative immunization effect is 28.13%, 48.99%, 65.26%, and 73.45%, respectively. When the concentration of 2,6-diamino-3-methylcaproic acid was higher than 1,000 nM, the disease index of susceptible wheat varieties infected with powdery mildew is lower than 50, while the relative immunization effect is more than 50%. The best effect is achieved at the concentration of 10,000 nM. These results indicate that 2,6-diamino-3-methylhexanoic acid can improve the immunity of wheat to fungal disease powdery mildew, thereby inhibiting the infection and spread of powdery mildew in wheat leaves and preventing the development and spread of wheat powdery mildew.

### Example 4 (Field Trial on 2-Amino-3-Phenylbutyric Acid Induced Resistance of Wheat to Powella Alba Infection)

A solution of 2-amino-3-phenylbutyric acid at a concentration of 1,000 nM (with 0.02% by volume of surfactant Tween 20) was sprayed onto the stems and leaves in the field. The treatment included spraying 0.02% by volume of surfactant Tween 20 as an auxiliary control, and Atailing (30 g/mu) as a positive control, with two replications per treatment. After the spray, the disease grade of wheat in each treatment group was investigated, and the morbidity degree was recorded according to the grading standard of wheat powdery in the “Pesticides-Guidelines for the Field Efficacy Trails” (I), and the disease index and the relative immunization effect were calculated in the same manner as those of tomato spotted wilt. After the harvested wheat seeds were dried, the thousand grain weight of wheat seeds from different treatments was measured.

Grading Standard of Wheat Powdery Mildew (per leaf):
Grade 1: The area of diseased spots accounts for 5% or less of the whole leaf area;
Grade 3: The area of diseased spots accounts for 6%-15% of the whole leaf;
Grade 5: The area of diseased spots accounts for 16%-25% of the whole leaf;
Grade 7: The area of diseased spots accounts for 26%-50% of the whole leaf;
Grade 9: The area of diseased spots accounts for 50% or more of the whole leaf area.

It is found that a solution of 2-amino-3-phenylbutyric acid at a concentration of 1,000 nM can effectively improve the immunity of wheat to the fungal disease powdery mildew, and the disease index of wheat treated with this concentration is significantly lower than that of the auxiliary control. Moreover, the relative immunization effect and thousand grain weight are significantly higher than those of the auxiliary control group (Table 5). The disease index, relative immunization effect and thousand grain weight of wheat treated with 2-amino-3-phenylbutyric acid solution at a concentration of 1,000 nM are 25.30, 51.72% and 38.87 g, respectively, which are significantly better than those of the Atailing group. These results indicate that spraying 2-amino-3-phenylbutyric acid can improve the resistance of wheat to fungal disease powdery mildew.

TABLE 5
Effects of the three treatments on disease index, relative immunization
effect and thousand grain weight of wheat

| | disease | immunization | (%) thousand |
|---|---|---|---|
| treatment | index relative | effect | grain weight (g) |
| auxiliary control | 52.41 ± 7.47 a | 0 | 34.76 ± 0.35 c |
| Atailing(30 g/mu) | 40.06 ± 2.35 b | 23.55 | 36.56 ± 0.17 b |
| 1,000 nM | 25.30 ± 3.27 c | 51.72 | 38.87 ± 0.20 a |

### Example 5 (2-Amino-3-Phenylbutyric Acid and 2,6-Diamino-3-Methylhexanoic Acid Induced the Resistance of Arabidopsis thaliana to Pseudomonas syringae Infection)

2-amino-3-phenylbutyric acid was dissolved in sterile water and then gradiently diluted with sterile water into solutions of 100 nM, 1,000 nM, and 10,000 nM, and a blank control was set up, while 0.02% Tween 20 was added as surfactant. The Pseudomonas syringae PstDC3000 was coated on the LB plate and cultured at 28° C. for 48 hours. Single colonies were picked and inoculated into a 50 mL centrifuge tube containing 2 mL of medium, cultured at 28° C. on a shaker at 250 rpm. The change of OD₆₀₀ value of the bacterial solution was monitored every 1-2 hours until it reached 0.8, and the culture of the bacteria was stopped. 1 mL of the bacterial solution was transferred into a 1.5 mL sterile centrifuge tube and centrifuged at 8,000 rpm for 2 min to collect the precipitate. The supernatant was removed, and the precipitate was washed 3 times with 10 mM magnesium chloride and centrifuged, and finally the PstDC3000 was resuspended in 10 mM magnesium chloride to reach an OD₆₀₀ value of 0.001 for later use. The Arabidopsis thaliana seeds were soaked in 75% alcohol for 3 min, then washed 4 times with sterile water and planted in a Petri dish containing ½ MS medium. Twelve seeds were planted in each petri dish, and ½ MS petri dishes with seeds were vernalized at 4° C. for 3 d to break dormancy and then placed in a culture room at 22° C. with a light intensity of 100 μE m⁻²s⁻¹ (16 h light/8 h darkness). When the seedlings grew for 2 weeks, the 2-amino-3-phenylbutyric acid solutions at different concentrations were slowly poured into the petri dish until the whole Arabidopsis thaliana seedlings were submerged, and kept for 2-3 minutes, and then the treatment solution was poured out of the petri dish. The treatment was performed once every 24 h for a total of 2 treatments. 24 hours after the second treatment, the PstDC3000 suspension (OD₆₀₀=0.01) was inoculated onto the leaves of Arabidopsis thaliana by the same submerge method. After inoculation, the petri dish was closed with a medical breathable adhesive tape and placed in the culture room for further culture. After 3 days, the number of bacteria in different treatments was determined and the incidence of Arabidopsis thaliana was observed. The disease index was calculated in the same manner as that in Example 2.

Grading standard of Disease injury caused by PstDC3000 (per leave):
Grade 0: No diseased patches on the leaves;
Grade 1: The area of diseased spots accounts for 0%-10% of the whole leaf;
Grade 2: The area of diseased spots accounts for 10%-25% of the whole leaf;
Grade 3: The area of diseased spots accounts for 25%-50% of the whole leaf;
Grade 4: The area of diseased spots accounts for 50%-75% of the whole leaf;
Grade 5: The area of diseased spots accounts for 75%-100% of the whole leaf.

TABLE 6
Effects of 2-amino-3-phenylbutyric acid at different concentrations
on the number of bacteria in the leaves and disease index

| treatment concentration | CFU/mg | disease index |
|---|---|---|
| 0 | 3.02 × 10⁶ | 80.21 ± 7.29 a |

| | | | |
|---|---|---|---|
| 100 | nM | 2.40 × 10⁵ | 38.04 ± 1.04 b |
| 1,000 | nM | 2.13 × 10⁵ | 33.33 ± 4.17 c |
| 10,000 | nM | 1.34 × 10⁵ | 14.58 ± 4.17 d |

The results in Table 6 show that the number of bacteria per milligram of leaves gradually decreases as the concentration of 2-amino-3-phenylbutyric acid increases. When the treatment concentrations are 100 nM, 1,000 nM, and 10,000 nM, the number of bacteria per milligram of leaves decreases by 92.05%, 92.94%, and 95.56%, and the disease index decreases by 52.57%, 58.45%, and 81.82%, respectively. This suggests that 2-amino-3-phenylbutyric acid can stimulate the plants to produce immunity against Pseudomonas syringae, inhibit the accumulation of bacteria in plant leaves, and reduce the incidence of plant disease.

The effect of 2-amino-3-phenylbutyric acid to induce the resistance of Arabidopsis thaliana to Pseudomonas syringae infection was investigated according to the same method. The results are shown in Table 7:

TABLE 7
Effects of 2,6-diamino-3-methylhexanoic acid at different concentrations
on the number of bacteria in the leaves and disease index

| treatment concentration | CFU (mg) | disease index |
|---|---|---|
| 0 | 3.23 × 10⁶ | 85.67 ± 1.87 a |

| | | | |
|---|---|---|---|
| 100 | nM | 8.42 × 10⁵ | 42.01 ± 1.36 b |
| 1,000 | nM | 5.12 × 10⁵ | 37.57 ± 0.24 c |
| 10,000 | nM | 1.58 × 10⁵ | 19.86 ± 1.23 d |

The results in Table 7 show that the number of bacteria per milligram of leaves gradually decreases as the concentration of 2,6-diamino-3-methylhexanoic acid increases. When the treatment concentrations are 100 nM, 1,000 nM, and 10,000 nM, the number of bacteria per milligram of leaves decreases by 73.93%, 84.15%, and 95.11%, and the disease index decreases by 50.96%, 56.15%, and 76.82%, respectively. This suggests that 2,6-diamino-3-methylhexanoic acid can stimulate the plants to produce immunity against Pseudomonas syringae, inhibit the accumulation of bacteria in plant leaves, and reduce the incidence of plant disease.

### Example 6 (2-Amino-3-Phenylbutyric Acid and 2,6-Diamino-3-Methylhexanoic Acid Induced the Resistance of Arabidopsis thaliana to High Temperature Stress)

2-amino-3-phenylbutyric acid was dissolved in distilled water and then gradiently diluted with distilled water into solutions of 100 nM, 1,000 nM, and 10,000 nM, and a blank control was set up, while 0.02% Tween 20 was added as surfactant. Four groups of replicates were set up for each concentration, and set up a blank control at room temperature. Arabidopsis thaliana seeds were planted in a pot with a diameter of 8.5 cm at about 50 seeds per pot, and grown in a greenhouse at a temperature of 22° C., a humidity of 60%-70%, and a light intensity of 100 μmol m⁻²s⁻¹ (16 h light/8 h darkness). The treatment was initiated at the 21 d of seedling stage of Arabidopsis thaliana by spraying 2-amino-3-phenylbutyric acid solution on the leaf surface, and spraying twice within 24 hours. 24 hours after the second treatment, the plants were transferred to a light incubator at a temperature of 45° C. for high temperature stress treatment. After 12 h of treatment, they were treated in the dark at room temperature for 30 min, and then the chlorophyll fluorescence of the Arabidopsis thaliana leaves was measured with Plant Efficiency Handy PEA. Then, the plants were removed and transferred to a greenhouse at 25° C. for 7 days for recovery. The injured conditions of the plants were observed and the grade of hot injury was calculated, where the grading standard of heat injury is shown in Table 1, and the formula for calculating the heat injury index is as follows. The results of hot injury and fluorescence parameters are shown in Table 8.

$$Heat injury index ( \% ) = \frac{\sum Number of plants at each grade of injury \times Grade}{Highest grade \times Total number of plants treated} \times 100$$

TABLE 8
Grading standard of hot injury

| grade of hot injury | injury degree |
|---|---|
| 0 | the plant grows normally |
| 1 | less than ¼ of the leaves show wilting |
| 2 | ¼ to ½ of the leaves show wilting or yellowing |
| 3 | ½ to ¾ of the leaves show wilting or yellowing |
| 4 | ¾ or more of the leaves show wilting or yellowing |
| 5 | the plant dies |

TABLE 9
Effects of 2-amino-3-phenylbutyric acid on Arabidopsis thaliana
under high temperature stress

| treatment concentration | | PI_{ABS} | heat injury index (%) |
|---|---|---|---|
| blank control | | 42.79 ± 5.47 a | 0 |
| 0 | | 14.27 ± 5.96 c | 72 |
| 100 | nM | 26.13 ± 7.37 bc | 47 |
| 1,000 | nM | 27.27 ± 3.93 bc | 31 |
| 10,000 | nM | 33.40 ± 3.91 b | 16 |

The results in Table 9 show that, after the high temperature stress, the photosynthetic performance index PI_{ABS} of Arabidopsis thaliana treated with 2-amino-3-phenylbutyric acid is significantly higher than that of the group not treated with 2-amino-3-phenylbutyric acid. The heat injury index decreases with the increase of the treatment concentration, where the best effect is achieved at 10,000 nM, and the photosynthetic performance index PI_{ABS} of Arabidopsis thaliana treated at this concentration increases by 134%, and the heat injury index decreases by 56%. It can be seen that 2-amino-3-phenylbutyric acid can alleviate the injuries of high temperature stress to the photosynthetic system of Arabidopsis thaliana plants and improve the resistance of Arabidopsis thaliana to high temperature stress.

The concentrations of 2,6-diamino-3-methylhexanoic acid used in this trail are 0, 1, 10, 100 and 1,000 nM, and 0.02% Tween 20 is added as a surfactant. Four groups of replicates were set up. Other methods were the same as 2-amino-3-phenylbutyric acid, and the effect of 2,6-diamino-3-methylhexanoic acid to induce the resistance of Arabidopsis thaliana to high temperature stress was investigated. The results were shown in Table 10:

TABLE 10
Effects of treatment with 2,6-diamino-3-methylhexanoic acid
on Arabidopsis thaliana under high temperature stress

| treatment concentration | | PI_{ABS} | heat injury index (%) |
|---|---|---|---|
| blank control | | 26.16 ± 2.03 a | 0 |
| 0 | | 0.26 ± 0.01 f | 73 |
| 1 | nM | 1.84 ± 0.02 e | 49 |
| 10 | nM | 3.58 ± 0.11 d | 38 |
| 100 | nM | 5.73 ± 0.17 c | 29 |
| 1,000 | nM | 9.49 ± 0.14 b | 9 |

The results in Table 10 show that, under the high temperature stress conditions, the photosynthetic performance index PI_{ABS} of Arabidopsis thaliana treated with 2,6-diamino-3-methylhexanoic acid significantly increases, and the heat injury index significantly decreases. With the increase of the concentration of 2,6-diamino-3-methylhexanoic acid, the heat injury index of Arabidopsis thaliana gradually decreases, while the photosynthetic performance index PI_{ABS} increases significantly compared with the control group. In particular, at the concentration of 1,000 nM, the photosynthetic performance index PI_{ABS} of Arabidopsis thaliana increases dramatically, with a 36 fold increase compared with the control group, while the heat injury index decreases by 64%. It can be seen that 2,6-diamino-3-methylhexanoic acid can alleviate the injuries of high temperature stress to the photosynthetic system of Arabidopsis thaliana and improve the resistance of Arabidopsis thaliana to high temperature stress.

### Example 7 (2,6-Diamino-3-Methylhexanoic Acid Induced the Resistance of Ryegrass to High Temperature Stress)

2,6-diamino-3-methylhexanoic acid was dissolved in distilled water and then gradiently diluted with distilled water into solutions of 1 nM, 10 nM, 100 nM, and 1,000 nM, and a blank control was set up, while 0.02% Tween 20 was added as surfactant. Four groups of replicates were set up for each concentration, and set up a blank control at room temperature. Ryegrass seeds were weighed and planted in a pot with a diameter of 8.5 cm at 0.8 g per pot, and transferred to a greenhouse with a temperature of 25° C., a humidity of 60%-70%, and a light intensity of 200 μmol m⁻²s⁻¹ (12 h light/12 h darkness). After 7 days of growth, ryegrass was treated by spraying 2,6-diamino-3-methylhexanoic acid solution on the leaf surface, and spraying twice within 24 hours. 24 hours after the second spray, the plants were transferred to a light incubator at 45° C. for high temperature stress treatment. After 12 hours of treatment, they were removed and transferred to a greenhouse at 25° C. for 7 days for recovery. The injured conditions of the plants were observed and the grade of hot injury was calculated, where the grading standard of heat injury is shown in Table 8, and the formula for calculating the heat injury index is as follows. The results of hot injury are shown in Table 11.

$$Heat injury index ( \% ) = \frac{\sum Number of plants at each grade of injury \times Grade}{Highest grade \times Total number of plants treated} \times 100$$

TABLE 11
Effects of 2,6-diamino-3-methylhexanoic acid
on ryegrass under high temperature stress

| treatment concentration | heat injury index (%) |
|---|---|
| blank control | 0 |
| 0 | 91 |

| | | |
|---|---|---|
| 1 | nM | 60 |
| 10 | nM | 54 |
| 100 | nM | 40 |
| 1,000 | nM | 22 |

The results in Table 11 show that, after high temperature stress, the heat injury index of ryegrass treated with 2,6-diamino-3-methylhexanoic acid is obviously lower than that of the control group, and the heat injury index gradually decreases with the increase of the treatment concentration. The heat injury index of the ryegrass decreases by 69% when the treatment concentration increases to 1,000 nM. It can be seen that 2,6-diamino-3-methylhexanoic acid can alleviate the injuries of high temperature stress to ryegrass plants, and improve the resistance of ryegrass to high temperature stress.

### Example 8 (2-Amino-3-Phenylbutyric Acid and 2,6-Diamino-3-Methylhexanoic Acid Induced the Resistance of Tea Tree to Low Temperature Stress)

The tea tree tested was cutting seedling of Baiye 1. Tea seedlings with consistent growth were selected and transplanted into plastic pots with a diameter of 18 cm and placed in a greenhouse with a temperature of 25° C. and a humidity of 60%-70% for adaptive growth for about a week for the experiment. The concentrations used in this experiment were 0, 100, 1,000, and 10,000 nM, and 0.02% Tween 20 was added as surfactant, where the spray treatment method was the same as that of Arabidopsis thaliana in Example 1, the duration of low temperature stress was 24 hours, and the temperature was set to −4° C. After the stress was completed, the tea seedlings were removed and after 30 min of dark treatment at room temperature, the chlorophyll fluorescence of the top leaves of the tea seedlings was measured with Plant Efficiency Handy PEA. The tea seedlings were then placed in a greenhouse at 25° C. for 3 days for recovery. Then the condition of cold injury was observed and graded, where the grading standard of cold injury is shown Table 12, the formula for calculating the cold injury index is as follows. The results are shown in Table 13.

$$Cold injury index ( \% ) = \frac{\begin{matrix}\sum Number of plants at corresponding grades of cold injury \times \\ Grade of cold injury\end{matrix}}{Highest grade of cold injury \times Total number of plants} \times 100$$

TABLE 12
Grading standard of cold injury

| grade of cold injury | injury degree |
|---|---|
| 0 | the plant grows normally |
| 1 | slight water loss at leaf margin |
| 2 | serious water loss at leaf margin |
| 3 | serious water loss at leaf margin, |
| | and dehydration spots on the leaf |
| 4 | serious water loss at leaf margin, |
| | connected spots on the leaf, and |
| | shriveling of some leaves |
| 5 | water loss, shriveling and wilting of the whole leaf |

TABLE 13
Effects of treatment with 2-amino-3-phenylbutyric
acid on tea leaves under low temperature stress

| treatment concentration | | PI_{ABS} | cold injury index (%) |
|---|---|---|---|
| 0 | | 17.15 ± 1.55 c | 75 |
| 100 | nM | 21.83 ± 1.73 bc | 66.33 |
| 1,000 | nM | 33.67 ± 3.27 b | 45 |
| 10,000 | nM | 42.36 ± 3.51 a | 40 |

The results in Table 13 show that, under the low temperature stress conditions, the photosynthetic performance indices PI_{ABS} of tea leaves treated with 2-amino-3-phenylbutyric acid all significantly increased, and the cold injury indices significantly decreased, where the best effect is be achieved at 10,000 nM, and the PI_{ABS} of the tea leaves treated at this concentration increases by 147%, and the cold injury index decreases by 35%. It can be seen that, 2-amino-3-phenylbutyric acid alleviates significantly the injuries of low temperature stress to the structure and function of photosynthetic system and function of tea seedlings, and improves the resistance of tea leaves to low temperature stress.

The concentrations of 2,6-diamino-3-methylhexanoic acid used in the trail were 0, 1, 10, 100, and 1,000 nM, and 0.02% Tween 20 was added as surfactant. The effect of 2,6-diamino-3-methylhexanoic acid to induce the resistance of tea to low-temperature stress was investigated according to the method as described above. The results are shown in Table 14:

TABLE 14
Effects of treatment with 2,6-diamino-3-methylhexanoic
acid on the tea leaves under low temperature stress

| treatment concentration | | PI_{ABS} | cold injury index (%) |
|---|---|---|---|
| 0 | | 18.14 ± 1.12 e | 71 |
| 1 | nM | 25.53 ± 0.09 d | 46 |
| 10 | nM | 32.44 ± 1.51 c | 42 |
| 100 | nM | 37.41 ± 0.14 b | 33 |
| 1,000 | nM | 40.14 ± 0.15 a | 26 |

The results in Table 14 show that, under the low temperature stress conditions, the photosynthetic performance indices PI_{ABS} of tea leaves treated with 2,6-diamino-3-methylhexanoic acid significantly increase, and the cold injury index significantly decrease, where the best effect is achieved at 1,000 nM, and the PI_{ABS} of the tea leaves treated at this concentration increases by 121%, and the cold injury index decreases by 45%. It can be seen that 2,6-diamino-3-methylhexanoic acid can alleviate the injuries of low temperature stress on the photosynthetic system of tea seedlings and improve the resistance of tea leaves to low temperature stress.

### Example 8:2-Amino-3-Phenylbutyric Acid and 2,6-Diamino-3-Methylhexanoic Acid Induced the Resistance of the Wheat to Drought Stress

Wheat was hydroponic cultured in a 6-mesh sieve used as a container at 50 grains per sieve, and ½ Hoagland nutrient solution was changed every three days. When the wheat grew to the stage of two leaves and one bud, 2-amino-3-phenylbutyric acid solution was sprayed on the leaf surface, and the concentration of 2-amino-3-phenylbutyric acid was 0, 100 and 1,000 nM, and 0.02% Tween 20 was added as surfactant. After two days of continuous spraying, the hydroponic nutrient solution was replaced with ½ Hoagland nutrient solution containing 25% PEG-6000 on the 3rd day for stress treatment. After 6 days of drought stress, rehydration treatment was conducted. And after 7 days of recovery growth in normal nutrient solution, the drought injury index was observed and determined, and the root length and biomass were determined. The results are shown in Table 16.

The performance characteristics of drought injury of leaves are similar to those of salt injury. The rate of drought injury and the drought injury index are introduced by using the evaluation indexes of salt injury. The formula for calculating the drought injury index is as follows, and the grading standard of drought injury is shown in Table 15.

$$Drought injury index ( \% ) = \frac{\begin{matrix}\sum Grade of Drought injury \times \\ Number of plants at corresponding grades of drought injury\end{matrix}}{Total number of plants \times Highest grade of Drought injury} \times 100$$

TABLE 15
Grading standard of drought injury

| grade of | |
|---|---|
| drought | |
| injury | injury degree |
| 0 | no symptoms of drought injury |
| 1 | mild drought injury, with yellowing |
| | of a few leaf tips, margins or veins |
| 2 | moderate drought injury, with withering of |
| | about ½ of the leaf tips and margins |
| 3 | severe drought injury, with withering of |
| | most of leaf tips and margins or falling |

TABLE 16
Effects of treatment with 2-amino-3-phenylbutyric acid on the
biomass and drought injury index of wheat under drought stress

| | | | | | | | drought |
|---|---|---|---|---|---|---|---|
| | | fresh weight (g) | | dry weight (g) | | length | injury |
| treatment | | aboveground | underground | aboveground | underground | of root | index |
| concentration | | part | part | part | part | (cm) | (%) |
| 0 | | 6.13 ± 0.21 c | 2.92 ± 0.15 c | 0.73 ± 0.01 c | 0.34 ± 0.01 c | 13.14 ± 0.20 b | 73 |
| 100 | nM | 7.51 ± 0.24 b | 3.77 ± 0.23 b | 0.87 ± 0.01 b | 0.38 ± 0.01 b | 14.23 ± 0.12 a | 46 |
| 1,000 | nM | 8.97 ± 0.32 a | 4.53 ± 0.01 a | 0.94 ± 0.05 a | 0.43 ± 0.02 a | 14.70 ± 0.37 a | 27 |

The results in Table 16 show that the resistance of wheat to drought stress gradually enhances with the increase of the treatment concentration. At the two treatment concentrations, the fresh weight, dry weight, and root length of wheat are higher than those of the control group, which results in a significant reduction in the drought injury index of wheat. For example, compared with the control group, the root length of wheat seedlings treated with 2-amino-3-phenylbutyric acid at a concentration of 1,000 nM significantly increases by 11.87%, the fresh weights of aboveground and underground parts increase by 46.33% and 55.14% respectively, and the drought injury index decreases by 46%. This indicates that 2-amino-3-phenylbutyric acid could improve the resistance of wheat to drought stress.

The effect of 2,6-diamino-3-methylhexanoic acid to induce the resistance of wheat to drought stress was investigated according to the above same method. The results are shown in Table 17:

TABLE 17
Effects of treatment with 2,6-diamino-3-methylhexanoic acid on the biomass
and drought injury index of wheat under drought stress condition

| | | | | | | | drought |
|---|---|---|---|---|---|---|---|
| | | fresh weight (g) | | dry weight (g) | | length | injury |
| treatment | | aboveground | underground | aboveground | underground | of root | index |
| concentration | | part | part | part | part | (cm) | (%) |
| 0 | | 6.20 ± 0.03c | 3.01 ± 0.02 c | 0.79 ± 0.02 c | 0.35 ± 0.01 c | 13.20 ± 0.16 c | 80 |
| 100 | nM | 7.70 ± 0.02 b | 3.79 ± 0.01 b | 0.94 ± 0.01 b | 0.42 ± 0.01 b | 14.35 ± 0.08 b | 40 |
| 1,000 | nM | 8.99 ± 0.01 a | 4.59 ± 0.03 a | 1.05 ± 0.01 a | 0.49 ± 0.01 a | 14.63 ± 0.12 a | 21 |

The results in Table 17 show that the resistance of wheat to drought stress gradually enhances with the increase of the treatment concentration. At the two treatment concentrations, the fresh weight, dry weight, and root length of wheat are higher than those of the control group, which results in a significant reduction in the drought injury index of wheat. For example, compared with the control group, the root length of wheat seedlings treated with 2,6-diamino-3-methylhexanoic acid at a concentration of 1,000 nM significantly increases by 9.77%, the fresh weights of aboveground and underground parts increase by 31.03% and 34.42%, respectively, and the drought injury index decreases by 59%. This indicates that 2,6-diamino-3-methylcaproic acid could improve the resistance of wheat to drought stress.

### Example 9:2-Amino-3-Phenylbutyric Acid and 2,6-Diamino-3-Methylhexanoic Acid Induced the Resistance of Cotton to Salt Stress

The experimental material was “Sikang 1” cotton, which was hydroponic cultured in a 500 mL plastic cup and ½ Hoagland nutrient solution was changed every three days. When the cotton seedling grew until the second true leaf fully unfolded, the leaf surface was sprayed with 2-amino-3-phenylbutyric acid solution. The concentrations used in this experiment were 0, 1, 10, 100, and 1,000 nM, and 0.02% Tween 20 was added as surfactant. The spraying was repeated once every 24 hours for a total of 2 times. On the second day after the treatment, NaCl was added to the ½ Hoagland nutrient solution to a final concentration of 100 mM to perform salt stress treatment. Each treatment was performed in triplicate. After three days of salt stress, rehydration treatment was performed, the salt injury symptoms of cotton were observed, and calculate the salt injury index was calculated. The formula is as follows:

$$Salt injury index ( \% ) = \frac{\sum Number of diseased plants at all grades \times Corresponding grade}{Total number of plants investigated \times Highest grade of salt injury} \times 100$$

TABLE 18
Grading standard of salt injury

| grade of | |
|---|---|
| salt injury | injury degree |
| 1 | The height of the plant and number of leaves are comparable to those of the |
| | control treatment. The plant is robust, and the leaves are flat, green, and shiny. The |
| | plant grows normally, with no symptoms of injury. |
| 2 | The height of the plant is 70%-100% of the control. The number of true leaves is |
| | 0.5-1.0 less than that of the control treatment, the cotyledons are flat without |
| | obvious symptoms of salt injury, and the growth is basically normal. |
| 3 | The height of the plant is 50%-70% of the control. The number of true leaves is |
| | 1.0 less than that of the control treatment, the cotyledon margin is curled. |
| | The hight of the plant is less than 50% of the control. There is no true leaves, only |
| 4 | heart leaves survives, the growth points is passivated, the cotyledon is dark green, |
| | shrivelled, and the margin is curled. |
| 5 | The cotyledons fall off and the plant dries out and dies. |

TABLE 19
Effects of treatment with 2-amino-3-phenylbutyric
acid on cotton under salt stress

| treatment concentration | salt injury index (%) | mortality (%) |
|---|---|---|
| 0 | 77 | 73 |

| | | | |
|---|---|---|---|
| 1 | nM | 66.67 | 49 |
| 10 | nM | 55 | 46 |
| 100 | nM | 51 | 32 |
| 1,000 | nM | 42 | 28 |

The results in Table 19 show that, the salt injury index of cotton decreases with the increase of the concentration of 2-amino-3-phenylbutyric acid, and the plant mortality of each treatment group is lower than that of the control group. When the concentration is 1,000 nM, the salt injury index and mortality are the lowest, which are 42% and 28%, respectively. These results above show that 2-amino-3-phenylbutyric acid can induce better resistance of cotton to salt stress.

The effect of 2-amino-3-phenylbutyric acid to induce the resistance of cotton to salt stress was investigated according to the above method. The results are shown in Table 20:

TABLE 20
Effects of treatment with 2,6-diamino-3-methylhexanoic
acid on the cotton under salt stress

| treatment concentration | salt injury index (%) | mortality (%) |
|---|---|---|
| 0 | 82 | 74 |

| | | | |
|---|---|---|---|
| 1 | nM | 53 | 46 |
| 10 | nM | 49 | 40 |
| 100 | nM | 42 | 27 |
| 1,000 | nM | 36 | 23 |

The results in Table 20 show that, the salt injury index of cotton decreases with the increase of the concentration of 2,6-diamino-3-methylhexanoic acid, and the plant mortality of each treatment group is lower than that of the control group. When the concentration is 1,000 nM, the salt injury index and mortality are the lowest, which are 36% and 23%, respectively. These results above show that 2,6-diamino-3-methylhexanoic acid can induce better resistance of cotton to salt stress.

Chemically synthesized 2-amino-3-phenylbutyric acid and 2,6-diamino-3-methylhexanoic acid also have the same effect as biologically extracted ones. The preparation methods of 2-amino-3-phenylbutyric acid and 2,6-diamino-3-methylhexanoic acid do not affect their application and effect as immune resistance inducers.

What is claimed is:

1. A method comprising applying 2-amino-3-phenylbutyric acid and/or 2,6-diamino-3-methylhexanoic in the preparation of a plant immune resistance inducer.

2. A method comprising applying 2-amino-3-phenylbutyric acid and/or 2,6-diamino-3-methylhexanoic acid to improve resistance of plant to abiotic and/or biotic stresses, wherein the abiotic stresses are selected from any one or more of high temperature, low temperature, drought and/or salt stresses; the biotic stresses are selected from any one or more of fungal disease, bacterial disease, and viral disease stresses, the fungal disease being wheat powdery mildew; the bacterial disease being Pseudomonas syringae disease; and the viral disease being tomato spotted wilt.

3. The method according to claim 1, wherein the plants are selected from food crops, cash crops, and vegetables.

4. The method according to claim 3, wherein the food crops are wheat, the cash crops are ryegrass, tea, and cotton, and the vegetable are tomato.

5. A plant immune resistance inducer, comprising component A: any one or more of 2-amino-3-phenylbutyric acid and 2,6-diamino-3-methylhexanoic acid; Component B: a surfactant.

6. The plant immune resistance inducer according to claim 5, wherein the surfactant is Tween 20.

7. The plant immune resistance inducer according to claim 6, wherein the concentration of Tween 20 in the plant immune resistance inducer is 0.01-0.05% (v/v).

8. The plant immune resistance inducer according to claim 5, wherein the concentration of 2-amino-3-phenylbutyric acid or 2,6-diamino-3-methylhexanoic acid in the plant immune resistance inducer is 0.1-10,000 nM.

9. A method for improving resistance of plants to biotic and abiotic stresses, wherein applying to the target plant 0.1-10,000 nM of 2-amino-3-phenylbutyric acid or 2,6-diamino-3-methylhexanoic acid, or the plant immune resistance inducer according to claim 5.

10. The method according to claim 9, wherein the abiotic stresses are selected from any one or more of high temperature, low temperature, drought and/or salt stresses; the biotic stresses are selected from any one or more of fungal disease, bacterial disease, and viral disease stresses, the fungal disease being wheat powdery mildew; the bacterial disease being Pseudomonas syringae disease; and the viral disease being tomato spotted wilt.

11. The method according to claim 2, wherein the plants are selected from food crops, cash crops, and vegetables.

12. The method according to claim 11, wherein the food crops are wheat, the cash crops are ryegrass, tea, and cotton, and the vegetable are tomato.

13. A method for improving resistance of plants to biotic and abiotic stresses, wherein applying to the target plant 0.1-10,000 nM of 2-amino-3-phenylbutyric acid or 2,6-diamino-3-methylhexanoic acid, or the plant immune resistance inducer according to claim 6.

14. A method for improving resistance of plants to biotic and abiotic stresses, wherein applying to the target plant 0.1-10,000 nM of 2-amino-3-phenylbutyric acid or 2,6-diamino-3-methylhexanoic acid, or the plant immune resistance inducer according to claim 7.

15. A method for improving resistance of plants to biotic and abiotic stresses, wherein applying to the target plant 0.1-10,000 nM of 2-amino-3-phenylbutyric acid or 2,6-diamino-3-methylhexanoic acid, or the plant immune resistance inducer according to claim 8.

16. The method according to claim 13, wherein the abiotic stresses are selected from any one or more of high temperature, low temperature, drought and/or salt stresses; the biotic stresses are selected from any one or more of fungal disease, bacterial disease, and viral disease stresses, the fungal disease being wheat powdery mildew; the bacterial disease being Pseudomonas syringae disease; and the viral disease being tomato spotted wilt.

17. The method according to claim 14, wherein the abiotic stresses are selected from any one or more of high temperature, low temperature, drought and/or salt stresses; the biotic stresses are selected from any one or more of fungal disease, bacterial disease, and viral disease stresses, the fungal disease being wheat powdery mildew; the bacterial disease being Pseudomonas syringae disease; and the viral disease being tomato spotted wilt.

18. The method according to claim 15, wherein the abiotic stresses are selected from any one or more of high temperature, low temperature, drought and/or salt stresses; the biotic stresses are selected from any one or more of fungal disease, bacterial disease, and viral disease stresses, the fungal disease being wheat powdery mildew; the bacterial disease being Pseudomonas syringae disease; and the viral disease being tomato spotted wilt.

19. The plant immune resistance inducer according to claim 7, wherein the concentration of Tween 20 in the plant immune resistance inducer is 0.02% (v/v).
